(19) United States
(12) Patent Application Publication
(10) Pub. No.: US 2005/0159968 A1
(43) Pub. Date: Jul. 21, 2005

(54) Organizationally interactive task management and commitment management system in a matrix based organizational environment

(76) Inventor: Stephen Cozzolino, Califon, NJ (US)

Correspondence Address: ERNEST D. BUFF;ERNEST D. BUFF & ASSOCIATES, LLC., 231 SOMERVILLE ROAD, BEDMINSTER, NJ, 07921, US

(21) Appl. No.: 10/762,758

(22) Filed: Jan. 21, 2004

(51) Int. Cl. G06F 17/60

(52) U.S. Cl. 705/1; 705/7

(57) ABSTRACT

A task management and commitment management system installed enterprise wide in a matrix based organizational environment allows one-on-one interaction between an Originator and a Recipient in defining a task which is a part of a complex project. A graphically oriented software system incorporates the rules of interaction based on a task state machine diagram. The graphical interface uses Task Role and Task State to display appropriate buttons which may be activated to generate a task as an Originator, request a task of a Recipient, who may review the task, and accept it, decline it or modify it. After the task definition is accepted by the Originator and the Recipient, the Recipient completes the work required by the task and submits it to the Originator. The Originator reviews the submitted work and may accept it so that the Originator can close the task. If the Originator is not pleased with the submitted work, he may request rework of the task by the Recipient. All these interactions between the Originator and the Recipient at every stage are recorded by the system software and are visible to anyone who is in the upward, inline management of the organizational hierarchy. Inline managers can observe all the interactions of an employee on one or more matrix based projects and evaluate employee performance, providing accurate assessment. The visibility of every aspect of task interaction allows rapid modification of related tasks. The repository of all tasks from all employees provides first hand content for the performance appraisal, creates a task transaction repository for business process managers to mine for new efficiencies, archives indisputable evidence for a compliance audit, and provides a means to communicate information up inline management ranks.

### BACKGROUND OF THE INVENTION

1. Field of the Invention

The present invention relates to a task and commitment management system having an organizationally interactive hierarchy interface; and more particularly, to a task and commitment management system for specifically integrating the task management process with organizational hierarchy in a matrix based organizational environment.

2. Description of the Prior Art

Many approaches have been disclosed for managing project schedule and tasks in standard hierarchical inline management systems. In such systems, the tasks are assigned to employees strictly along management lines. On the other hand, in a matrix management system, the tasks are not assigned along the inline management hierarchy. Rather, in matrix management systems, tasks are assigned by different groups. This procedure requires tasks to be executed by employees, complicating the task management process. More so, the inline managers in charge of employee performance appraisals cannot do an effective job. Such inline managers are oftentimes unaware of all the tasks accomplished by the employees in view of their interactions with different groups working on a matrix based work environment.

U.S. Pat. No. 5,111,391 to Fields et al. discloses a system and method for making staff schedules as a function of available resources as well as employee skill level, availability and priority. This system and method includes a database for storing and retrieving information characterizing: central office policy of applicable labor requirements; tasks that need to be performed; and skill levels required to perform tasks. Upon request to create a schedule for a given day for a remote location, the system selects all the tasks to be performed on that day, for that location, analyzes the tasks, the skill required, the available resources, and creates an optimized display of the required schedules. It merely calculates what is a possible day-to-day schedule based on resources available and tasks assigned, and assigns tasks with no cooperation or participation by employees.

U.S. Pat. No. 5,164,897 to Clark et al. discloses an automated method for selecting personnel matched to job criteria. This automated method selects personnel matching employees having qualifications with job criteria using a data file that includes a plurality of records including job titles, industrial experience, special skills, and employee code. When the job criteria is defined the system uses a database file to match employees with required skill levels based on the priority of the job criteria. It does not require participation of employees involved or manage the tasks.

U.S. Pat. No. 5,233,533 to Edstrom et al. discloses a scheduling method and apparatus. A program determines where to manufacture a given item in the production process by looking backwards and forwards to meet a given delivery schedule, so that the plant utilization can be optimized. The '533 patent discloses a scheduling computation tool for optimizing plant resource utilization. No disclosure is contained therein concerning a task management tool in a matrix environment.

U.S. Pat. No. 5,530,861 to Diamant et al. discloses process enaction and tool integration via a task-oriented paradigm. A task manager provides personal organization, project management, and process automation capabilities. The task manager maintains a hierarchical list of tasks, which may be pre-defined and automatic or manually set, for an individual, tracking progress on tasks. The task manager communicates with agents, tools, and process engines via a message system. Such an individual task organization tool merely lists individual's tasks. It does not create and manage project tasks in a matrix based organizational system.

U.S. Pat. No. 5,765,140 to Knudson et al discloses a Dynamic project management system. A dynamic project management system includes a server network configured to identify a personnel resource pool and a master database. A project-planning tool is used to effect the project plan including a plurality of tasks to be performed by the users in accordance with respective time schedules. Time sheets are periodically prepared in the master database from the assignment table. A list of the project tasks is assigned to a respective user and a time period record is established for recording time entries. This dynamic project management system assigns project tasks and time schedules without any requirement that the employee agrees to perform the task within the specified time period. Also, the system disclosed by the '140 patent does not represent a matrix based organizational hierarchy. Each of the tasks is determined not by mutual cooperation, but by computer software, which assigns the tasks. No means are provided for an inline manager to assess individual performance.

U.S. Pat. No. 5,890,166 to Eisenberg et al. discloses a versioned-database management system (VDMS), that is provided with a method for determining candidates for promotion in association with a user task. The VDMS maintains a list of parts changed as a result of a user task, referred to as a promote group. When the parts associated with a user task for a given variant level are promoted, an iterative process is performed to determine the complete set of parts that must be promoted in support of the requested promote. In this versioned-database management system, tasks are associated with promote groups, which comprise a set of parts whose changes are to be promoted. Candidates are compared with respect to their user tasks, and candidates appointed for promotion are selected by the system. No disclosure is contained therein concerning a management system in a matrix-based organization.

U.S. Pat. No. 5,893,074 to Hughes et al. discloses a network based task management system. A large project is broken up into series of tasks and subtasks and set up as a contract between at least two responsible parties, i.e., a receiver and supplier of the product. The tasks consist of designs, mechanical or electrical parts, tests, or reports and are defined by the rec/del format. Data stored in the database are then analyzed with a computational component to determine the contract and states for each product. The data are processed and analyzed with the computational component to generate output data for the suppliers and receivers, thereby providing a schedule-control method. This large-scale schedule control project management control system ties up receiver and supplier parties who are not single individuals in a contract. It monitors transactions of exchange of designs, mechanical or electrical parts, tests, or reports to process and analyze using the computational component and generate output data for the suppliers and receivers. Decisions concerning changes to a task are not made by the suppliers and receivers. Instead, these decisions are made by the computational unit. No disclosure is contained therein concerning a task generation and monitoring system in a matrix based organizational system.

U.S. Pat. No. 5,926,794 to Fethe discloses a visual rating system and method. The raters rate an individual using a vertical bar that lists behavioral attributes. A scorecard provided by the system includes the ranking of the rater and a shaded area containing the range of all ratings. No disclosure is contained by the patent concerning a task management system. Rather the patent disclosure is directed to a visual performance appraisal system.

U.S. Pat. No. 6,049,776 to Donnelly et al. discloses a human resource management system for staffing projects. It selects a program staff based on skill level requirements set in the project need. No disclosure is therein contained concerning a task management system. The patent disclosure is, instead, directed to project staffing in accordance with skill set needs.

U.S. Pat. No. 6,076,105 to Wolff et al discloses distributed resource and project management. In this distributed project management system multiple clients on a network share control over and responsibility for a project defined in a project management folder that is stored on the network. The project management folder is accessed by the clients without requiring a central server, since access for read and write is determined by a table that resides in a distributed fashion. No disclosure is contained by the patent concerning task management. Instead the patent discloses a multiple project, multiple client network based system.

U.S. Pat. No. 6,092,048 to Nakaoka discloses a task execution support system. Multiple clients are serviced by the system, using a task information unit, which comprises a task entry memory unit, a task tree structure memory unit, an event rule memory unit, an action entry memory unit and an action property memory unit. Tasks are executed according to client set event rules. No disclosure is contained by the patent concerning a task management system. The patent instead discloses a system that services multiple clients according to their set event rules for executing a task.

U.S. Pat. No. 6,092,050 to Lungren et al. discloses a graphical computer system and method for financial estimating and project management. A graphical interface creates financial data for a bid process. No disclosure is contained by the patent concerning a task management system.

U.S. Pat. No. 6,101,481 to Miller discloses a task management system. A complex project is broken into series of simple tasks. Each task is defined between a task controller and task personnel who are responsible. The task modification process is accessible to the task controller or responsible task personnel solely, with the result that modifications are not visible to everyone in the system. This system does not provide ability for inline managers to assess the performance of an individual employee and conduct performance appraisal.

U.S. Pat. No. 6,308,164 to Nummelm et al. discloses a distributed project management system. An enterprise management system is thereby disclosed. Project managers input project data into the system. Such project data includes tasks, schedule and resources. The system uses primary data, which is essential for creating a project and secondary data, which may be used for verifying project data. The system disclosed by the patent does not define tasks between an originator and a recipient in a matrix based organization providing visibility of employee performance to inline managers with performance appraisal responsibility. Instead, it stores project data. Commercial software, such as Microsoft Project is used.

U.S. Pat. No. 6,445,968 to Jalla discloses a task manager. A computer program is used by the overall manager to allocate a work schedule of staff according to priority. The actual time spent on a task is subtracted from the estimated time planned by the overall manager and the resource can be allocated to the next priority task on a daily basis. The program disclosed by the patent does not facilitate project task management between an originator and a recipient in a matrix based organizational structure.

U.S. Pat. No. 6,524,109 to Lacy et al. discloses a system and method for performing a skill set assessment using a hierarchical minimum skill set definition. This system allows a user to assess the user's proficiency at performing a predetermined set of skills related to the user's employment position. The computer program analyzes the skill set of a user using a comprehensive skill set or a minimal skill set based on the definitions stored in the computer. No disclosure is contained therein concerning a task management system.

U.S. Pat. No. 6,591,278 to Ernst discloses a project data management system and method. A remote integration server links with the project management system, permitting multiple authorized users to communicate with the server to receive updated multiple project information. To preserve integrity of data only one person can change the project data at a given time. Tasks are not coordinated between an originator and a recipient for project task organization in a matrix based organizational system. Rather, project data is stored and transmitted to remote locations where authorized users operate.

U.S. Patent Application No. 2002/0052769 to Navani et al. discloses a computer system for providing a collaborative workflow environment. A computer program for petroleum traders allows a user to log into the system and negotiate deals, schedule vessels that deliver petroleum products and provide collaborative workflow. No disclosure is contained by the patent application concerning a task management system that interacts with an originator and a recipient for project task organization in a matrix based organizational system.

U.S. Patent Application No. 2002/0082895 to Budka et al. discloses a method, apparatus and article for project management. A remote server is used to display project level information, request level information and task level information on a particular project. Each of these elements can be modified if the user has sufficient authority. Interaction is extant between a machine and a person; but not between an originator and a recipient for project task organization in a matrix based organizational system. The machine merely displays the information or stores modified information when the person communicating has sufficient authority.

U.S. Patent Application No. 2002/0120489 to Matsuda et al. discloses a method and apparatus for managing information. Hierarchical order between jobs, sequence between jobs, relationship between the job and product are produced with the relationship between the job and additional information to order the sequence of management of information. No disclosure is contained therein concerning a task management system.

U.S. Patent Application No. 2002/0138322 to Umezawa et al. discloses a secure workflow system and method for the same. When an activity status changes, activity status data is updated. Also, rules data is defined to indicate rules based on combinations of this data that specify personnel that cannot carry out activities (denied users), positions that cannot carry out activities (denied positions), personnel that must carry out activities (required users), and positions that must carry out activities (required positions). When a workflow server assigns personnel to activities, a security server is used to provide access control. The security server uses history data, activity status data, subjects data, position hierarchy data, and rules data to determine denied users, denied positions, required users, and required positions. It evaluates access permissions and determines assignment candidates. This remote server connected to a network allows clients to view and modify data in a secure environment. No disclosure is contained by the patent application concerning a task management system that interacts with an originator and a recipient for project task organization in a matrix based organizational system.

U.S. Patent Application No. 2002/0143601 to Sinex discloses dynamic assignment of maintenance tasks to maintenance personnel. A program for maintenance of one or more aircraft based on FAA requirements and time a part is in service prior to replacement. No disclosure is contained by the patent application concerning task management software where an originator interacts with recipient on a specific task definition and execution in a matrix based organizational environment.

U.S. Patent Application No. 2002/0178036 to Murata et al. discloses a project management method and project management system. A software program collects information about the corresponding works as a compound work, on a subproject selected by the user and displays the information about the work on the compound-work basis. No disclosure is contained by the patent application concerning task management software wherein an originator interacts with a recipient on a specific task definition and execution within a matrix based organizational environment.

U.S. Patent Application No. 2003/0004767 to Ohsaki discloses a workflow system, information processor, and method and program for workflow management. Workflow management software enables a single person to manage several nodes based on the definition. The program determines if the person is ‘in charge’ and can work on the nodes. No disclosure is contained by the patent application concerning a task management software where an originator interacts with recipient on a specific task definition and execution in a matrix based organization.

U.S. Patent Application No. 2003/0033187 to Jones et al. discloses a project management system. This is for management of a construction project and requires an interaction between the planner and the software program. No disclosure is contained by the patent application concerning a task management software where an originator interacts with a recipient on a specific task definition and execution for project task organization in a matrix based organizational system.

U.S. Patent Application No. 2003/0046345 to Wada et al. discloses a system and method for project management. A network based project management system permits a user to view the schedule and tasks of a specific project to which he is authorized for access. Interaction is extant between a central computer system connected through a network and a user. No disclosure is contained by the patent application concerning task management software for project task organization in a matrix based organizational system wherein an originator interacts with a recipient on a specific task definition and execution.

U.S. Patent Application No. 2003/0055668 to Saran et al. discloses a workflow engine for automating business processes in scalable multiprocessor computer platforms. The system is automatically triggered in response to a business event which may be predetermined or based on receipt of fax, web message and the like. It has built in security for access of information. The patent application discloses a machine process; but does not disclose task management software for project task organization in a matrix based organizational system wherein an originator interacts with a recipient on a specific task definition and execution.

U.S. Patent Application No. 2003/0083891 to Lang et al. discloses a project management tool. A temporary employment human resource tool places pre-qualified candidates in a pool. The skill set of each candidate is matched against job requirements. New applicants can enter the pre-qualified candidate pool by providing their skill set to he system. A web based human resource tool employs temporary labor. No disclosure is contained by the patent application for a task management for a project task organization in a matrix based organizational system wherein an originator interacts with a recipient on a specific task definition and execution.

U.S. Patent Application No. 2003/0083953 to Starkey discloses a facility management system. The facility management system automatically generates information that is used to manage both a facility and the staff employed at the facility, with a high degree of integration and cross-correlation among the diverse attributes of the facility and services provided therein by the professional staff employed at the facility. It maintains a multidimensional database of work that is to be done by the staff as well as by contractors. The work is defined in terms of tasks that are linked to physical attributes of the facility as well as to staff to produce task Sheets that are integrated coherent descriptions of tasks that are assigned to Staff. No disclosure is contained by the patent application concerning task management software for use in a matrix-based organization.

U.S. Patent Application No. 2003/0101086 to San Miguel discloses a decision tree software system. The compliance level for meeting corporate standards, regulation and standards issues is increased by setting tasks in a browser networked environment. No disclosure is contained by the patent application concerning task management software for use in a matrix based organizational structure.

U.S. Patent Application No. 2003/0130881 to Calderaro et al. discloses a system and method for automated resource reduction analysis. A human resource tool accessed by executive management, division management, project managers, department managers and human resource professionals determines redundancies in skill sets to identify surplus resources. No disclosure is contained within the patent application concerning task management software for a matrix-based organization wherein an originator interacts with a recipient in connection with a specific task definition and execution.

U.S. Patent Application No. 2003/0135384 to Nguyen discloses a workflow process method and system for iterative and dynamic command generation and dynamic task execution sequencing, including an external command generator and a dynamic task execution sequencer. A computer-implemented method dynamically activates process activities based on initial data, target data; constructs a plurality of activity nodes; evaluates them with a rules evaluator using pre-determined rules; and generates the next activity node. A computer implemented workflow generation process is disclosed; not task management software for use in a matrix-based organization.

U.S. Patent Application No. 2003/0135401 to Parr discloses a method and process of program management for the owner's representative of design-build construction projects. An owner's representative system providing a structure, method, and process of program management in the field of building construction is described. This construction project management system allows creation of project activities, review activities and detailed phase information and the road map of the project. No disclosure is contained within the patent application concerning task management software for use in a matrix-based organization in which an originator interacts with a recipient on a specific task definition and execution.

U.S. Patent Application No. 2003/0137541 to Massengale et al. discloses a graphical user interface for project data. The graphical interface allows the user to view, edit and navigate project data. This is a communication between a user and a remote server connected over a network. There is no disclosure in the patent application for a task management system for use in a matrix-based organization.

U.S. Patent Application No. 2003/0149714 to Casati et al. discloses dynamic task assignment in workflows with a method of assigning resources to nodes in a workflow. It assigns nodes in a workflow, after which resources are assigned to the nodes. A set of rules and constraints are defined in determining the workflow through the nodes. This is a task assignment process for determining the workflow, not a task management software for use in a matrix-based organization wherein an originator interacts with a recipient in connection with a specific task definition and execution.

Internet Publication “A Task Management Model in CSCW” at http://www.cs.umd.edu/users/liaomay/publication/TAMM.pdf. discloses a task management model on CSCW, wherein TAMM, task activity management model is used. TAMM classifies the cooperative works into two categories as synchronous cooperation and asynchronous cooperation. This is a theoretical model of a single worker or group of workers working on different tasks at the same time or at different times. No disclosure is contained by the Internet Publication concerning task management software for matrix-based organizations in which an originator interacts with a recipient in connection with a specific task definition and execution.

Internet Publication ‘Compliance Navigator’ at http://www.pointstar.com/Compliance/ComplianceNavigator.pdf. details a compliance navigator™ which manages compliance activities using task management, authoring and issue tracking. No disclosure is contained therein concerning task management software for use in a matrix-based organization.

There remains a strong need in the art for an organizationally interactive task management system in a matrix based organizational environment, wherein a complex project is broken down to several individual tasks and an originator can assign an individual tasks to a recipient on a one-on-one basis. Also needed is a system wherein the recipient is provided with an opportunity to accept, decline or modify the task, work on the task, submit the task and all of these interactions are recorded by the system and are visible to inline managers responsible for employee performance evaluations based on organizational hierarchy. Further needed is a system that empowers employees to undertake and perform on matrix-based projects that are assigned by various originators, and are rewarded for their performance by inline managers that conduct performance evaluations.

### SUMMARY OF THE INVENTION

The invention provides an organizationally interactive task management and commitment management system in an organizational environment, especially one characterized by matrix groups and activities. The enterprise wide software system is an integration of a task state machine with organizational hierarchy providing visibility of all tasks and commitments for the benefit of management. The system software comprises the task state machine (FIG. 1), which defines the means by which two employees can interact with each other for the purpose of generating, canceling, requesting, modifying, negotiating, accepting, declining, revising and completing a singular task or a task that is part of a large project. A user's choices concerning actions to be taken on a task depend on that user's task role (Originator, Recipient, or None), and the task state (Generate, Accept, Request, Submit, Close, Cancel or Decline). Since the task state machine diagram is too detailed for the average user, the software application generates a simple, user centric graphical task state diagram based on the user's role on the currently selected task and the current task state, providing appropriate actions that are available. A user centric tool-tip is also provided in the software.

All task states from Generate to Close are recorded to a relational database on the server. The program uses this repository for management visibility, report generation, event triggers, and data mining.

The enterprise wide software system may reside in a single computer serving all the employees or may reside in a distributed secure network such as an Intranet or the Internet, or in a traditional client server network, as is well known in the art. The employees may use the software online with fast immediate interactions, which are recorded, or offline if no network connection is available. The software program uses Microsoft's new ADO.NET database technology in which a mirror set of tables and relationships are created as a set of programmatic objects in the C# programming language. Microsoft calls this a disconnected record set because the application only needs to connect to the server long enough to send and receive the appropriate data. One advantage of this is that the application can be used offline just like e-mail. The data can be replicated with the server immediately upon the user's request or it will be automatically replicated at a specified interval (1, 5, 10, or 20 minutes).

The system uses a software program that embodies every detail of the task state machine, which defines the possible interaction between an Originator and a Recipient of a task that represents a portion or subset of tasks in a project. The Originator defines the task that includes details and time frame of the task, and sends it to a Recipient starting a task negotiation process. At this stage, the Originator may modify the task or cancel it before sending it to the Recipient. The Recipient, upon receipt of the request, examines the task and may decide to accept it, decline it or change the details or time frame of the task; and the Recipient's action is received by the Originator. This negotiation process commits the Recipient for the task and is recorded by the system, which provides a commitment management function.

When the Recipient completes the task, he submits the task results to the Originator. The Originator may accept it and close the task or reject it because the work is deemed satisfactory. He may decide to have additional work done and request the Recipient to start another negotiation process. The submission as well as the desire for rework is recorded by the system.

A third party has visibility rights to observe what is happening in a particular stage of the task management process. The visibility rights are provided through the hierarchy of the organizational chart of the enterprise. With the exception of the CEO, every employee has one direct manager and zero or more indirect managers. Both direct and indirect managers are referred to as inline managers. Therefore a third party has visibility rights to a task if he/she is the inline manager of the Originator or Recipient. This rule cascades hence the same third party has visibility rights of their subordinate's subordinates's tasks and so forth until the lowest level of the hierarchy. Therefore a person at a higher level always has visibility rights for observing task details of a lower level person so long as they are connected through inline managers. This complete visibility provides the ability for inline managers that are responsible for performance evaluations to clearly observe details of negotiations and work output delivered by the employee. The employees obtain full credit for all the work performed in a matrix organizational environment wherein the tasks are delivered to the employees through unconnected management lines and the inline manager does not need to participate as a middleman in the negotiations between an Originator and a Recipient.

As a result of this delicate negotiation process, tasks are clearly defined with inputs from both the Originator and a Recipient creating an open environment wherein project work and individual tasks are worked on with well defined objectives for successful outcomes. Since every step of the task definition process is clearly visible and recorded, other tasks affected by a particular change in a given task can be easily modified and addressed on a real time basis. One does not have to wait until a task is complete to find that the task that was accomplished was irrelevant to the overall objectives of a project.

The Organizationally Interactive Task Management and Commitment Management System incorporates several primary features, which are highly advantageous:
1. A complex project broken into a set of tasks between the Originator and the Recipient;
2. Selective interaction between the Originator of a task and the Recipient of a task, wherein the Originator defines a task to be executed by the Recipient;
3. Opportunity for the Recipient to accept, decline or modify the task assigned to him;
4. Opportunity for the Originator to (a) accept the modification, or (b) reject it, or (c) cancel the task;
5. Opportunity for the Recipient to complete the work and submit it to the Originator or partition the work into one or more subtasks;
6. Opportunity for the Originator to accept the work and close the task or send it back for rework from the Recipient;
7. The entire interaction between the Originator and the Recipient is completely visible to everyone within the upward, inline management hence management is able to seamlessly monitor the progress of a single step of a complex project which has a task of interaction between an Originator and a Recipient, and
8. Due to this visibility managers can assess performance and reward employees regardless of reporting structure and improve performance by changing Originator-Recipient options.

This system has significant advantages to managers charged with the responsibility of rewarding employees, conducting performance appraisals and managing operations.
1. Managers can view all work performed by their subordinates for any historical period in a multitude of different reports. Managers can also see the work of their subordinate's subordinates, ad infinitum, until the lowest tier of the hierarchy.
2. Managers can create employee performance appraisals for their subordinates based on first hand work data derived directly from the subordinate's task transactions. A balanced and factual performance appraisal can be generated by pulling tasks that are commensurate for each performance-criteria from the database.
3. Managers can discover and better retain hidden performers because they have visibility of everyone's task transactions in the downward reporting hierarchy.
4. Managers can mine the database for recurring tasks and multiple, linked recurring tasks to discover inefficiencies and consequently redesign a business process to gain efficiencies.
5. This management structure empowers employees to request work from each other because their work will be visible to their respective managers regardless of whether or not the task is being performed on behalf of someone in their reporting hierarchy.
6. Managers can immediately view in detail or in summary the multitude of linked tasks that generate over the course of a mid or longer term goal.
7. Managers now have an efficient means of proving compliance for state and federal audits of laws and regulations by providing credible first hand evidence of who performed what action and when.
8. Managers additionally now have an efficient means of measuring in-house operational procedure to ensure procedural compliance. For example, no corner cutting as evidenced in either time to completion or steps to completion; or the level of inefficiencies present as viewed by time exceeding standard practice or redundant steps within or across departments.

### BRIEF DESCRIPTION OF DRAWINGS

The invention will be more fully understood and further advantages will become apparent when reference is had to the following detailed description and the accompanying drawings, in which:

FIG. 1 is a process flow diagram depicting operation of the task state machine;

FIG. 2 is a User Centric Task Diagram providing user centric help, and showing a Task Role Originator and a Task State Generate;

FIG. 3a is a User Centric Task Diagram providing user centric help, and showing a Task Role Originator and a Task State Request;

FIG. 3b is a User Centric Task Diagram providing user centric help, and showing a Task Role Recipient and a Task State Request;

FIG. 3c is a User Centric Task Diagram providing user centric help, and showing a Task Role None —Visible Rights Only, and a Task State Request;

FIG. 4a is a User Centric Task State Diagram providing user centric help, and showing a Task Role Originator and a Task State Accept;

FIG. 4b is a User Centric Task State Diagram providing user centric help, and showing a Task Role Recipient and a Task State Accept;

FIG. 4c is a User Centric Task State Diagram providing user centric help, and showing a Task Role None —Visible Rights Only and a Task State Accept;

FIG. 5a is a User Centric Task State Diagram providing user centric help, and showing a Task Role Originator and a Task State Submit;

FIG. 5b is a User Centric Task State Diagram providing user centric help, and showing a Task Role Recipient and a Task State Submit;

FIG. 5c is a User Centric Task State Diagram providing user centric help, and showing a Task Role None —Visible Rights Only and a Task State Submit;

FIG. 6a is a User Centric Task State Diagram providing user centric help, and showing a Task Role Originator and a Task State Close;

FIG. 6b is a User Centric Task State Diagram providing user centric help, and showing a Task Role Recipient and a Task State Close;

FIG. 6c is a User Centric Task State Diagram providing user centric help, and showing a Task Role None —Visible Rights Only and a Task State Close;

FIGS. 7a and 7b depict an Employee Centric Reporting Hierarchy;

FIGS. 8a and 8b depict a change request process for the Originator;

FIGS. 9a and 9b depict a change request process for the Recipient; and

FIG. 10 is a Change Request state when the change proposed by the Originator is accepted by the Recipient.

### DESCRIPTION OF THE PREFERRED EMBODIMENTS

In the course of the last two decades, organizations have expanded their reach and tailored their products to meet the needs of different geographically located markets. Further, the Internet has shrunk the world into an on-screen directory of products and services thereby increasing every competitor's reach. These long standing trends have increased competition and forced companies to restructure from a bureaucratic command and control to a hierarchy of employees who play cross-functional roles in matrix groups that service dynamic needs.

The paradigm shift in organizational structure has not been matched by a corresponding shift in employee motivation. Despite the structural changes, employees feel obligated almost entirely to tasks that are requested by direct managers yet feel little obligation to perform tasks requested by fellow employees because they are not rewarded for performing the work or reprimanded for declining the work. This should come as no surprise since employees' basic desires are recognition and increased compensation, both of which necessitate the awareness of direct management in all activities. Managers have only a dim view of their employees' matrix activities and are therefore unable to provide feedback.

The standard metric of review and recognition is the performance appraisal. This technique for providing periodic feedback on job performance has wide variation in implementation but it is generally regarded as difficult to administer uniformly and effectively. Faults with current implementations include the halo effect (biasing outstanding work in one area over all other areas), the recency effect (heavily weighting recent behavior), and impression management (the tendency of individuals to subtly affect a manager's opinion by performing at a higher level when visible). These problems are partially caused by the inherent difficulty in adding content when no repository of transactions of tasks and task output exist. Significant improvement to the content of reviews could be attained if performance appraisals could be populated with first hand documented task transactions of the employee under review. Performance appraisals are also the primary means in which wrongful termination suits are settled and many suits are lost because appraisals lack content. “Because it is easier to check a box than to write a comment, meaningful comments usually are scant. Yet, meaningful comments are critical if a performance appraisal has to be defended in court.”¹
¹ COPYRIGHT 1995 Society for Human Resource Management

A solution to the inadequacies of performance appraisals and matrix based work requests would be a system or apparatus for negotiating a task transaction and persisting the stages of the transaction to a repository. Such a system would also bring efficiencies to disciplines of business process engineering, corporate compliance, and vision translation. The benefits of the system are explained in more detail below.

Business process engineering aims at providing a better output while reducing the cost of the input: time and resources. Corporations do this by examining their fundamental processes in search of efficiencies. Since no repository of current processes exists, workers must be interviewed to determine the current method. This discovery process would be expedited if a history existed of the sequence, duration, and content of the task transactions.

Corporate compliance to state and federal regulations for workers' rights have been well observed in part due to software to help human resource departments administer such laws. However, newer regulations regarding fiscal compliance lack conformity. Procedural compliance, a set of operating rules that govern a department or team's functioning with regard to their particular skill set, are affected by state and federal regulations as well. Organizations would benefit if a sequence of task transactions could be recalled that showed who did what, when and over what duration.

Vision translation is defined as the process in which a high level goal, abstract in form and issued by senior management, transforms into concrete tasks as it flows down through the ranks. All too common in today's organization, iterative and infrequent meetings communicate the information up and down the corporate hierarchy. These communications are subject to flaws, limited knowledge of how the vision is being carried out across divisional and departmental boundaries or by “yes men” who misrepresent directives that inherently change the vision. Again, this process would benefit from a system that captured tasks as they originate in real-time and give appropriate visibility rights for the content. Senior management would benefit greatly from the objective view into the organization provided by the hierarchal visibility of all task transactions.

The solution to the aforementioned problems is a dynamic management system implemented in a software application that enables employees to solicit work from coworkers and perform work for coworkers both inside and outside of their direct reporting lines, to formalize task transaction by binding the communication to the task state machine, to persist all states of the transaction to a database, and to make that work visible to inline managers for the purpose of recognition, reward and operational management. This effectively corrects the motivational disconnect that currently exists in matrix activities, provides first hand content for the performance appraisal, creates a task transaction repository for business process managers to mine for new efficiencies, archives indisputable evidence for a fiscal compliance audit, and generates a real time view of a vision translation.

By accepting a task request through this task management system as opposed to an undocumented verbal conversation or a static e-mail, the employee has made an explicit commitment to their coworker and an implicit commitment to the organization due to the default visibility rights given to the management hierarchy of employees that partook in the work transaction. Thus work is shifted from a relationship dependent, inter-employee plea to a managerially visible corporate commitment, thus, the apt name commitment management. The software-based solution is intended to be used by everyone in the corporate office from the highest levels of management to lowest reporting level.

The present invention provides a software system installed enterprise wide for the management of task generation, task commitment, task execution and task submission, wherein the tasks are a part of a complex project and involve interaction between an Originator and a Recipient in the form of one-on-one negotiation. This negotiation defines the agreed upon task and creates a commitment between the Originator and the Recipient. Both the task details agreed upon as well as the commitment between two employees responsible for a single task, which is a part of a complex project, is entered in the enterprise wide system.

The task generation process is a result of negotiations between the task Originator and the task Recipient and negotiations may include but are not limited to task details, task time frame, dollar commitment for the task and the like. As a result of these negotiations, the Recipient accepts the task from the Originator and proceeds to work on the task. If the requested task requires work of other employees, the Recipient of the task breaks down his task into other smaller tasks and requests other employees to do a sub task for the Recipient. In this case, the Recipient becomes an Originator for the sub task and the person requested becomes a sub task Recipient and this is also done by mutual negotiations. When the task work is complete, the Recipient submits the results of the work to the task Originator using the enterprise wide software. The submission is generally in the form of Rich Text Format, RTF file, or other compatible file structures in accord with filters installed in the enterprise wide software. The Originator reviews the submitted work and either accepts and closes the task or requests a rework on the task.

The details of task generation, task execution and task submission are visible to the organization based on organizational hierarchy. The task details can be viewed by anyone upward, in the inline management of the Originator or the Recipient. Thus all the inline managers can observe the details of every employee and their interactions in a matrix based organization. This generates an unbiased view of an employee's activities and task outputs resulting in a fair and accurate assessment of employee's performance.

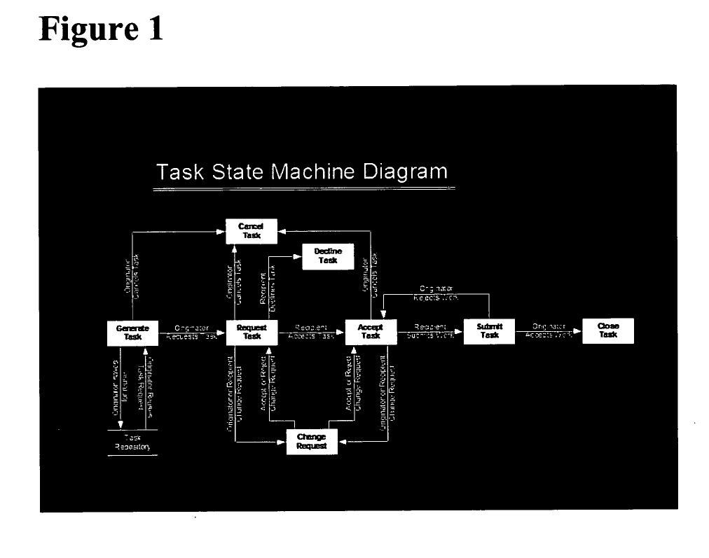

Project management software programs that provide the ability to delegate or request tasks are known in the art. The Organizationally Interactive Task Management System differs from these programs by integrating the task state machine and organizational hierarchy to manage tasks and commitment in a matrix based organizational environment and provides visibility of task details based on the organizational hierarchy for the benefit of management and action. Project management and the Organizationally Interactive Task Management System also differ in intent and consequently the type of activities that are recorded. Project management starts with the intent of managing a preconceived multi-step goal, typically managed in a directive style of task delegation. In contrast, the Organizationally Interactive Task Management System starts with the intent of enforcing a task request through the task state machine for the purpose of visibility and accountability to management and the empowerment of work done for the benefit of the organization. The latter is more dynamic and real-time because it doesn't require a preconceived multi-step goal yet post conceived tasks and sub tasks can still be linked as they spawn in real-time. Therefore the content of the tasks recorded through the Organizationally Interactive Task Management System are vastly broader in scope and provide a never before collated view of corporate activities in real-time which is significantly more efficient than the current mechanism of recursive meetings that slowly and inefficiently communicate information up a hierarchy. Because both project management and the Organizationally Interactive Task Management System differ in the type of tasks recorded, the two software applications will have minimal overlap and will coexist in an organization. In operation of the Organizationally Interactive Task Management System, the task state machine defines the means by which two employees can interact with each other for the purpose of generating, canceling, requesting, negotiating, accepting, declining, revising and completing a task. A process flow diagram depicting operation of the task state machine is set forth in FIG. 1. All task state changes are recorded to a database on the server. The Originator defines a task using the generate process and requests the task from a Recipient. The Recipient can accept the task as defined, declines the task or requests the task to be modified. The Originator can accept the modification or cancel the task. Then the Recipient gets to work on the task. He submits the results of the work through the enterprise wide software system. The Originator can accept the submitted work and close the task or reject the work, requesting rework.

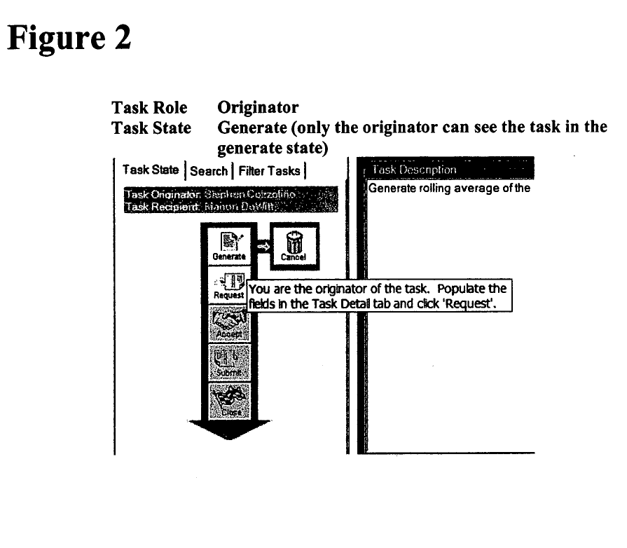

A user's choices concerning the actions to be taken on a task depend on that user's task role (Originator, Recipient, or None), and the task state (Generate, Accept, Request, Submit, Close, Cancel or Decline). Since the Task State Machine diagram is too detailed for the average user, the application generates a simple graphical state diagram based on the user's role on the currently selected task and the current task state. A user centric task state diagram and user centric help is set forth in FIGS. 2 through 10.

FIG. 1 illustrates a process flow diagram depicting operation of the task state machine. The task state machine allows operation of an Organizationally Interactive Task Management System, wherein a task state machine defines the means by which two employees can interact with each other for the purpose of generating, canceling, requesting, negotiating, accepting, declining, revising and completing a task. A user's choices concerning the actions to be taken on a task depend on that user's task role (Originator, Recipient, or None), and the task state (Generate, Accept, Request, Submit, Close, Cancel or Decline). The task is generated by the Originator, which may have been selected from the task repository as a reuse. Of course, the Originator can cancel this task. The Originator logs in a task request and is directed to a Recipient. The Recipient can accept the task as defined by the Originator, or create a change request modifying the original task. The Originator may accept or reject the changes and may decide to cancel the task. The Recipient may indicate that he declines the task as defined by the Originator. If the Recipient accepts the task with or without changes requested, the Originator may still cancel the task since it may not meet his need. At his stage the Recipient accepts the work and the Originator has not cancelled the task. The Recipient submits the work to the Originator and the Originator may accept or reject the work. If he accepts the work, the task is closed since the task is completed. If the Originator rejects the work, the task is moved back to the accept state thus the Originator may cancel the task or place a change request and wait for acceptance by the Recipient or may wait for the original task to be reworked. If the Originator rejects the work, the Recipient can rework the task and submit the work or place a change request and wait for acceptance by the Originator.

Since the Task State Machine diagram is too detailed for the average user, the application generates a simple graphical task state diagram based on the user's role on the currently selected task and the current task state. A user centric task state diagram and user centric help is set forth in FIGS. 2 through 10. A well-defined graphic user interface clearly indicates the user's task role and the task state. The user's task role is automatically populated as ‘Originator’ based on the action of generating a task or automatically populated as ‘Recipient’ based on the Originator selecting an employee to be the Recipient of a task. The task state is automatically populated as the ‘Generate’, ‘Request’, ‘Accept’, ‘Submit’, ‘Close’, ‘Cancel’, and ‘Decline’ as the Originator and Recipient progress through the options available to them dictated by the task state machine. The graphical interface of the software is shown in detail in FIGS. 2 through 10.

FIG. 2 presents the graphical interface of the user centric task state diagram and user centric help. As previously stated, the program automatically populates the task role. If the user instructs the program to create a new task, then the user is the Originator. An Originator automatically becomes an indirect manager and has visibility rights in the sub tasks of a multi-task project. In FIG. 2, the user's Task Role is Originator, and the Task State is Generate. In this case, the Originator can only see the appropriate buttons, which include Generate, Request, Accept, Submit, Close, and Cancel. The current task state, Generate, is shown in yellow. In the Generate state for the Originator, the Request and Cancel buttons are active as shown in white and the Accept, Submit, and Close buttons are inactive and dimmed in gray. The task fields are entered and populated by the Originator. If the user drags the mouse over the yellow Generate button, the user centric help tip will appear. In this case, the user centric help states, “You are the originator of the task. Populate the fields in the Task Detail tab and click ‘Request’.” This is the task generation process.

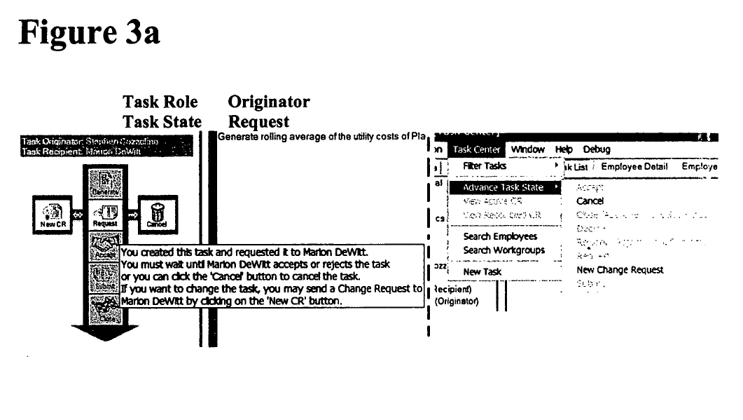

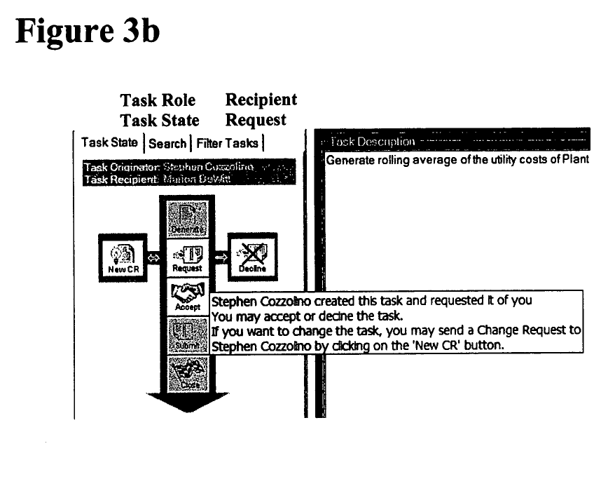

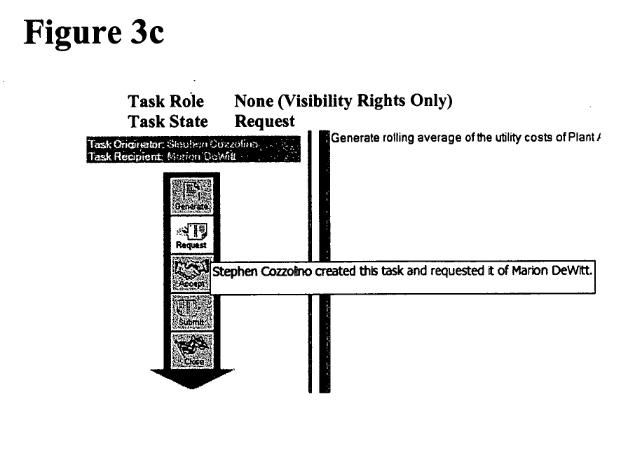

FIG. 3 represents the graphical interface of the user centric task state diagram and user centric help during three situations. In FIG. 3a shown, the task role is Originator and the task state is Request and the picture has been split to show that the active menu items exactly match the available choices in the user centric task state diagram. In this case, the Originator can only see the appropriate buttons, which include Generate, Request, Accept, Submit, Close, New CR and Cancel. The current task state, Request is shown in yellow. In the Request state for the Originator, the New CR and Cancel buttons are active as shown in white and the Generate, Accept, Submit and Close buttons are inactive and dimmed in gray. If the user drags the mouse over the yellow Request button, the user centric tool tip help will appear. In this case, the user centric help states “You created this task and requested it to Marion DeWitt. You must wait until Marion DeWitt accepts or rejects the task or you can click the ‘Cancel’ button to cancel the task. If you want to change the task, you may send a Change Request to Marion DeWitt by clicking on the ‘New CR’ button.” This is the task request process for the Originator.

In the second situation, shown by FIG. 3b, the user's Task Role is Recipient, and the Task State is Request. In this case, the Recipient can only see the appropriate buttons, which include Generate, Request, Accept, Submit, Close, New CR and Decline. The current task state Request is shown in yellow. In the Request state for the Recipient, the New CR, Accept, and Decline buttons are active as shown in white and the Generate, Submit, and Close buttons are inactive and dimmed in gray. If the user drags the mouse over the yellow Request button, the user centric help tip will appear. In this case, the user centric help states, “Stephen Cozzolino created this task and requested it of you. You may accept or decline the task. If you want to change the task, you may send a Change Request to Stephen Cozzolino by clicking on the ‘New CR’ button.” This is the task Request process for the Recipient.

In the third situation, shown by FIG. 3c, the user's Task Role is None (Visibility Rights Only), and the Task State is Request. A third party can view a list of tasks for any employee in the organization. Only tasks that the third party has visibility rights to will appear in the list. A third party has visibility rights if he/she, their department, or their division, is copied on the task or if they are a member of the upward, inline management of the Originator or the Recipient. Even though a third party cannot directly change the task's state, a third party can contribute comments to a task and change request comment log. This feedback allows upper management to communicate to the Originator and Recipient for general comments on the task and for comments directly related to a change request. Or, a third party can search the task list of an employee, department, division, or corporation for a keyword to look for a particular task. In this case, the third party can only see the appropriate buttons, which include Generate, Request, Accept, Submit, and Close. The current task state, Request, is shown in yellow. Since the user is a third party to the task, no action may be taken. If the user drags the mouse over the yellow Request button, the user centric help tip will appear. In this case, the user centric help states, “Stephen Cozzolino created this task and requested it of Marion DeWitt.” This is the task Request process for a third party.

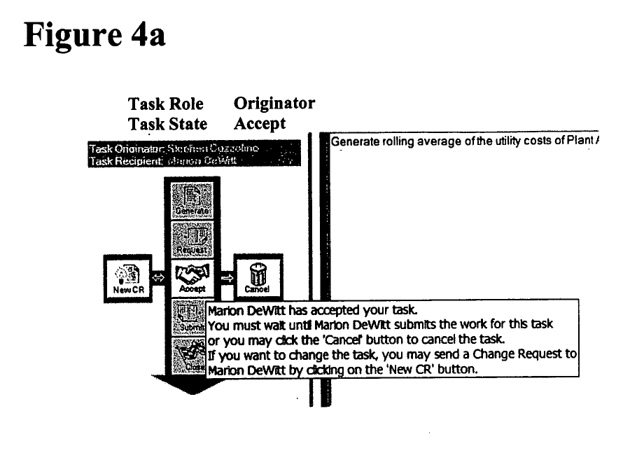

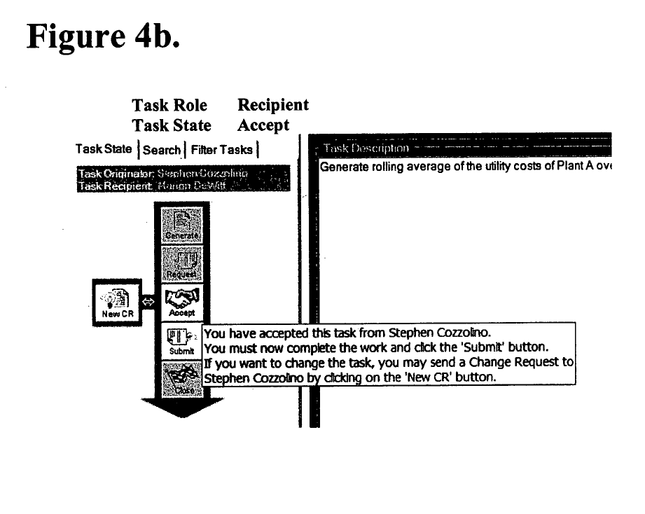

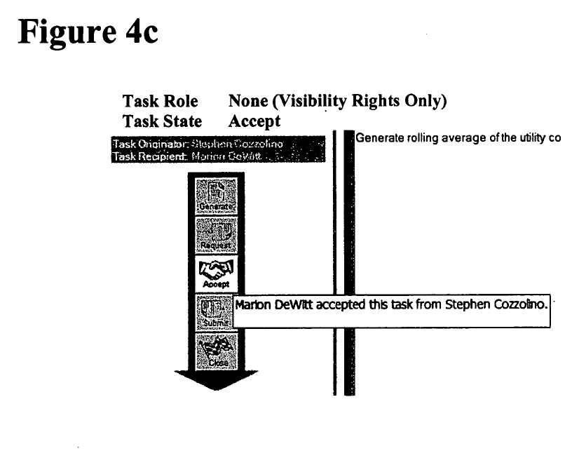

FIG. 4 represents the graphical interface of the user centric task state diagram and user centric help during three situations. In the first situation, FIG. 4a, the user's Task Role is Originator, and the Task State is Accept. In this case, the Originator can only see the appropriate buttons, which include Generate, Request, Accept, Submit, Close, New CR and Cancel. The current task state, Accept, is shown in yellow. In the Accept state for the Originator, the New CR and Cancel buttons are active as shown in white and the Generate, Request, Submit, and Close buttons are inactive and dimmed in gray. If the user drags the mouse over the yellow Accept button, the user centric help tip will appear. In this case, the user centric help states, “Marion DeWitt has accepted your task. You must wait until Marion DeWitt submits the work for this task. If you want to change the task, you may send a Change Request to Marion DeWitt by clicking the ‘New CR’ button.” This is the task Accept process for the Originator.

In the second situation, FIG. 4b, the user's Task Role is Recipient, and the Task State is Accept. In this case, the Recipient can only see the appropriate buttons, which include Generate, Request, Accept, Submit, Close, and New CR. The current task state, Accept, is shown in yellow. In the Accept state for the Recipient, the New CR and Submit buttons are active as shown in white and the Generate, Request, and Close buttons are inactive and dimmed in gray. If the user drags the mouse over the yellow Accept button, the user centric help tip will appear. In this case, the user centric help states, “You have accepted this task from Stephen Cozzolino. You must now complete the work and click the ‘Submit’ button. If you want to change the task, you may send a Change Request to Stephen Cozzolino, the Originator, by clicking on the ‘New CR’ button.” This is the task Accept process for the Recipient.

In the third situation, shown by FIG. 4c, the user's Task Role is None (Visibility Rights Only), and the Task State is Accept. In this case, a third party with visibility rights can only see the appropriate buttons, which include Generate, Request, Accept, Submit, and Close. The current task state, Accept, is shown in yellow. Since the user is a third party to the task, no action may be taken. If the user drags the mouse over the yellow Accept button, the user centric help tip will appear. In this case, the user centric help states, “Marion DeWitt accepted this task from Stephen Cozzolino.” This is the task Accept process for a third party.

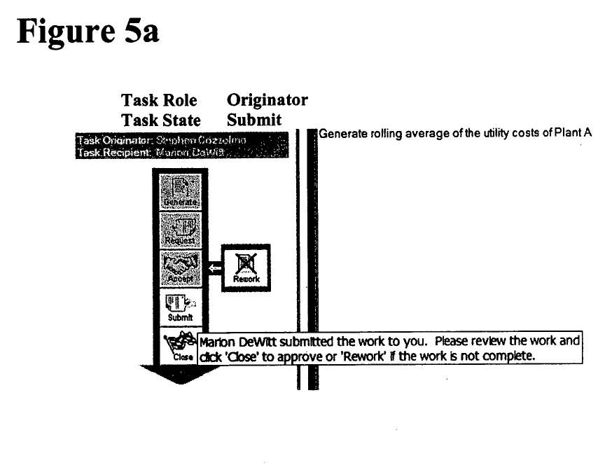

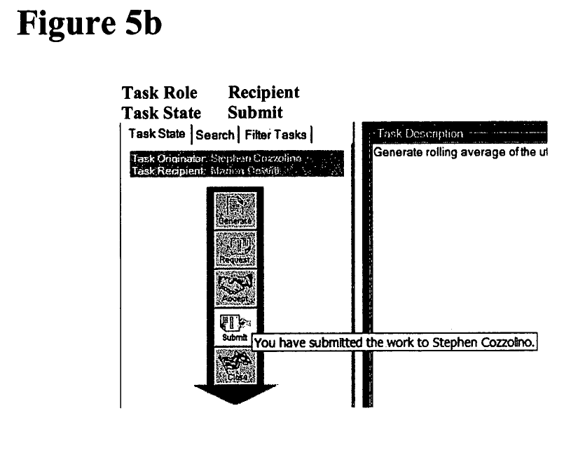

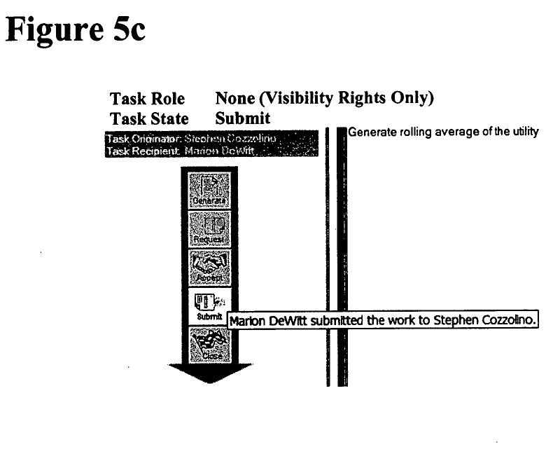

FIG. 5 represents the graphical interface of the user centric task state diagram and user centric help during three situations. In the first situation, FIG. 5a, the user's Task Role is Originator, and the Task State is Submit. In this case, the Originator can only see the appropriate buttons, which include Generate, Request, Accept, Submit, Close, and Rework. The current task state, Submit, is shown in yellow. In the Submit state for the Originator, the Close and Rework buttons are active as shown in white and the Generate, Request, and Accept buttons are inactive and dimmed in gray. If the user drags the mouse over the yellow Submit button, the user centric help tip will appear. In this case, the user centric help states, “Marion DeWitt submitted the work to you. Please review the work and click ‘Close’ to approve or ‘Rework’ if the work is not complete.” This is the task Submit process for the Originator.

In the second situation, FIG. 5b, the user's Task Role is Recipient, and the Task State is Submit. In this case, the Recipient can only see the appropriate buttons, which include Generate, Request, Accept, Submit, and Close. The current task state, Submit, is shown in yellow. In the Submit state for the Recipient, all other buttons are inactive and dimmed in gray. If the user drags the mouse over the yellow Submit button, the user centric help tip will appear. In this case, the user centric help states, “You have submitted the work to Stephen Cozzolino.” The program uses RTF files as attachments, and files of other format may be used as well, based on the filters loaded into the software program. This is the task Submit process for the Recipient.

In the third situation, shown by FIG. 5c, the user's Task Role is None (Visibility Rights Only), and the Task State is Submit. In this case, a third party with visibility rights can only see the appropriate buttons, which include Generate, Request, Accept, Submit, and Close. The current task state, Submit, is shown in yellow. Since the user is a third party to the task, no action may be taken. If the user drags the mouse over the yellow Submit button, the user centric help tip will appear. In this case, the user centric help states, “Marion DeWitt submitted the work to Stephen Cozzolino.” This is the task Submit process for a third party. A third party may view an RTF compliant attached file.

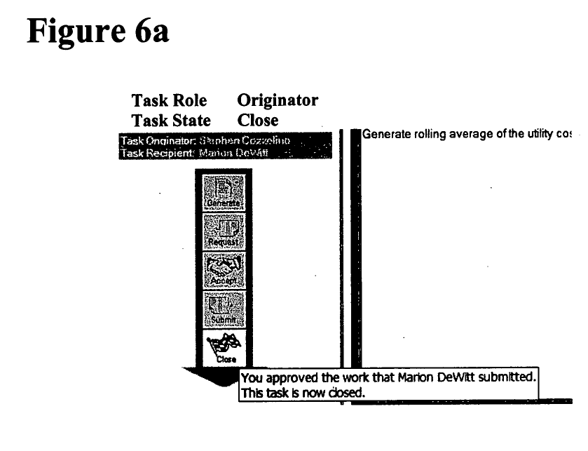

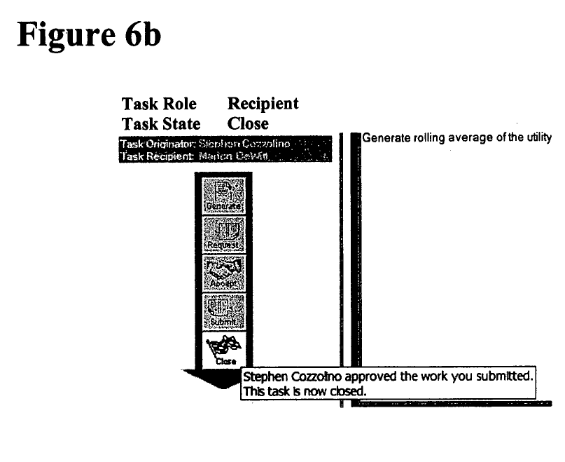

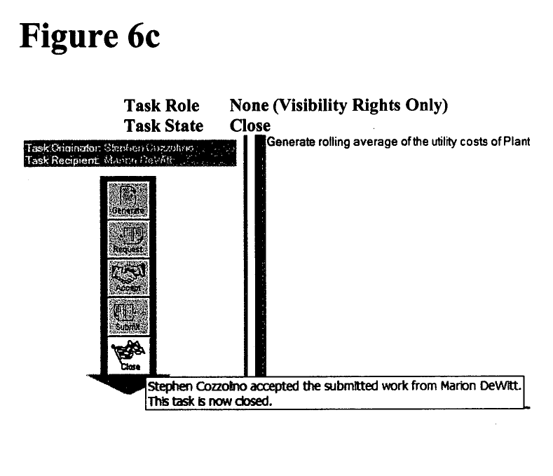

FIG. 6 represents the graphical interface of the wherein user centric task state diagram and user centric help during three situations. In the first situation, FIG. 6a, the user's Task Role is Originator, and the Task State is Close. In this case, the Originator can only see the appropriate buttons, which include Generate, Request, Accept, Submit, and Close. The current task state, Close, is shown in yellow. No actions may be taken by anyone when a Task reaches the Close state therefore the buttons Generate, Request, Accept, and Submit are inactive and dimmed in gray. If the user drags the mouse over the yellow Close button, the user centric help tip will appear. In this case, the user centric help states, “You approved the work that Marion DeWitt submitted. This task is now closed.” This is the task Close process for the Originator.

In the second situation, shown by FIG. 6b, the user's Task Role is Recipient, and the Task State is Close. In this case, the Recipient can only see the appropriate buttons, which include Generate, Request, Accept, Submit, and Close. The current task state, Close, is shown in yellow. No actions may be taken by anyone when a Task reaches the Close state therefore the buttons Generate, Request, Accept, and Submit are inactive and dimmed in gray. If the user drags the mouse over the yellow Submit button, the user centric help tip will appear. In this case, the user centric help states, “Stephen Cozzolino approved the work you submitted. The task is now closed.” This is the task close process for the Recipient.

In the third situation, shown by FIG. 6c, the user's Task Role is None (Visibility Rights Only), and the Task State is Close. In this case, a third party with visibility rights can only see the appropriate buttons, which include Generate, Request, Accept, Submit, and Close. The current task state, Close, is shown in yellow. No actions may be taken by anyone when a Task reaches the Close state therefore the buttons Generate, Request, Accept, and Submit are inactive and dimmed in gray. If the user drags the mouse over the yellow Submit button, the user centric help tip will appear. In this case, the user centric help states, “Stephen Cozzolino accepted the submitted work from Marion DeWitt. This task is now closed.” This is the task Close process for a third party.

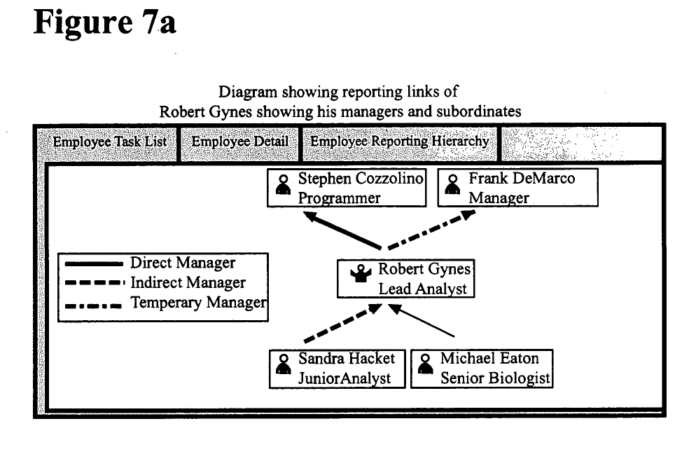

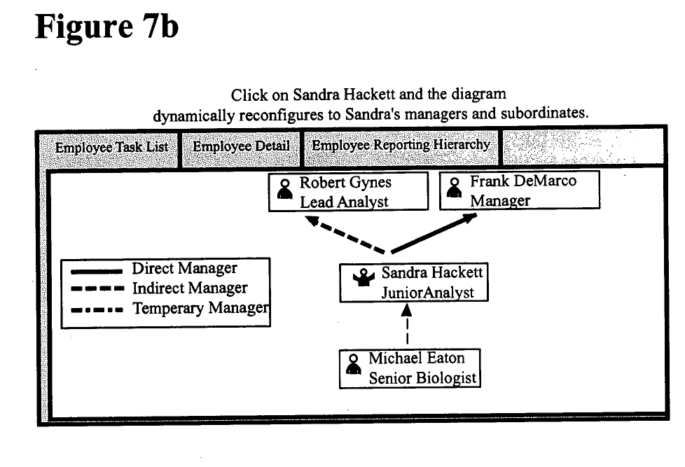

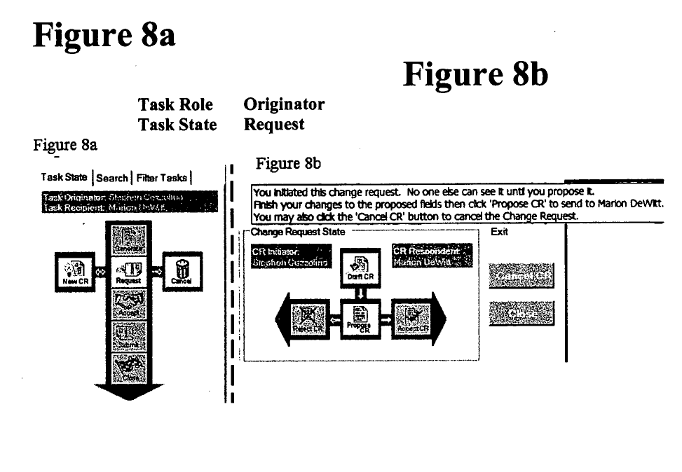

FIG. 7 represents the graphical interface of the Employee Centric Reporting Hierarchy. This diagram, at FIG. 7a, shows the reporting links for the selected employee. It shows direct, indirect and temporary managers and direct reports, indirect reports and temporary reports for a particular employee, Robert Gynes. In this example, Robert Gynes reports directly to Stephen Cozzolino and temporarily to Frank DeMarco. Robert Gynes is the indirect manager of Sandra Hacket and the direct manager of Michael Eaton. Therefore Robert will have visibility rights to the tasks in which Sandra or Michael partake as Originator or Recipient. Stephen and Frank will have visibility rights of Robert's, Sandra's and Michael's tasks. FIG. 7b shows the Employee Centric Reporting Hierarchy after clicking on Robert's indirect report, Sandra Hacket. In this example, Sandra Hacket reports directly to Frank DeMarco and indirectly to Robert Gynes. Michael Eaton reports indirectly to Sandra Hacket. Therefore Sandra has visibility rights to Michael's tasks and Robert and Frank have visibility of Sandra's and Michael's tasks. The Recipient or the Originator can place a change request in the Request or Accept Task States. FIG. 8a shows the task Originator creating a Draft Change Request. The person who creates the Change Request is referred to as the CR Initiator and the person responding to Change Request is referred to as the CR Respondent. In this example, the CR Initiator is the task Originator, Stephen Cozzolino. The task Originator starts a Change Request by clicking on the New CR button, shown in FIG. 8a. FIG. 8b shows the Change Request State Diagram, which also uses user centric based tool tip help. In the Draft CR state, the CR Initiator makes changes to the task fields then proposes the request by clicking on the Propose CR button. The task states Reject CR and Accept CR are dimmed.

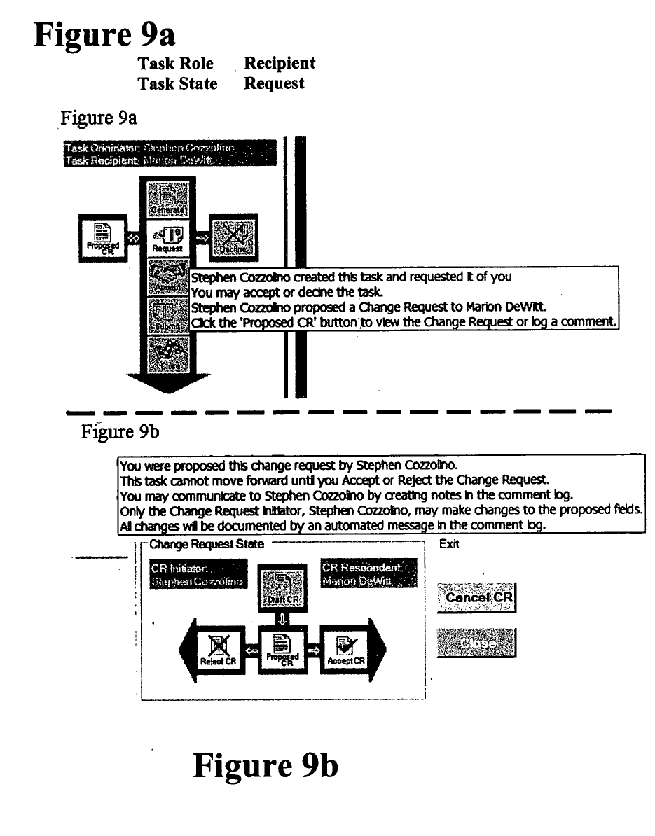

In FIG. 9a, the Task State is Request and the user's Task Role is Recipient. As opposed to the user centric task state diagram in FIG. 3b, the Decline and Accept buttons are dimmed because the Recipient must accept or reject the Change Request before accepting or declining the task. In this example, the CR Respondent is the task Recipient, Marion DeWitt. Marion may log a note to the Change Request comments fields, accept the Change Request or reject the Change Request.

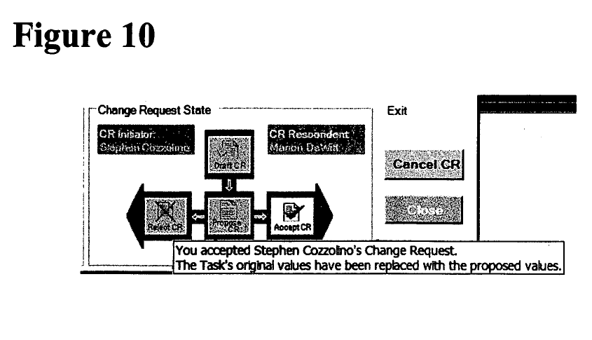

FIG. 10 shows the Change Request State after the CR Respondent, Marion DeWitt, accepted the Change Request. Now that the pending Change Request has been resolved Marion DeWitt is able to Accept or Decline the task. Thus the program permits negotiation of task details including work to be performed, time frame of work and details of relevant tasks between an Originator and a Recipient and represents a subset of a large project. The task details may be changed by the Originator or the Recipient of the task and each has the right to accept, modify or decline the proposed task. This negotiation commits the Recipient to a task and work is made visible through the program. The program provides automatic visibility to all upward, inline managers of the Originator and Recipient hence the managers can view the details of negotiation and submissions and time spent in accomplishing the task. This provides detailed information of employee performance to inline managers who have the responsibility of conducting performance evaluations and salary/promotion planning human resource functions. This process empowers the employees to negotiate the most optimum task execution strategy and enhances the project execution speed and quality. Since every detail of every aspect of the project is clearly detailed and visible, a high level person can assess any portion of the project that is not progressing at the desired speed. He may choose to create additional tasks to augment these slow progress tasks or change strategies in real time.

Having thus described the invention in rather full detail, it will be understood that such detail need not be strictly adhered to, but that additional changes and modifications may suggest themselves to one skilled in the art, all falling within the scope of the invention as defined by the subjoined claims.

1. An enterprise wide task and commitment management system for monitoring and recording single tasks forming part of a project performable by two employees that function as a task Originator and a task Recipient in a matrix based organization, comprising:
a. task state machine system software means for enforcing the rules of the task state machine, incorporating schema required by the task state machine diagram; and persisting all task state changes to a relational database.
b. task state machine graphic interface means associated with said system software for providing ability to transact tasks, and for providing visibility of task related details to employees based on organizational hierarchy.

2. An enterprise wide task and commitment management system as recited by claim 1, wherein said system software means is resident on a single server computer.

3. An enterprise wide task and commitment management system as recited by claim 1, wherein said system software means is distributed over a secure network, such as an Intranet or an Internet.

4. An enterprise wide task and commitment management system as recited in claim 1 wherein said task state machine graphic interface means incorporates said task state diagram and is based on a Task Role of Originator, Recipient, None—(Visual Rights only), and Task State of Generate, Request, Accept, Submit, Close, Decline and Cancel.

5. An enterprise wide task and commitment management system as recited by claim 4 wherein the Task Role is Originator and said Task State is Generate, defining a task.

6. An enterprise wide task and commitment management system as recited in claim 4 wherein the Task Role is Originator and said Task State is Request, requesting a defined task from a Recipient.

7. An enterprise wide task and commitment management system as recited in claim 4 wherein the Task Role is Recipient and said Task State is Request, said defined task being evaluated by the Recipient to determine if the task should be accepted, declined or modified.

8. An enterprise wide task and commitment management system as recited in claim 4 wherein the Task Role is Recipient or Originator and said Task State is Request or Accept, said defined task being modified by invoking New Change Request.

9. An enterprise wide task and commitment management system as recited in claim 4 wherein the Task Role is None—(Visibility rights only) and Task State is Request, said defined task being viewable by any one in the enterprise who has implicit visibility rights because they are in the upward, inline management of the Originator or the Recipient of the task.

10. An enterprise wide task and commitment management system as recited in claim 4 wherein the Task Role is Recipient and Task State is Accept, said defined task being accepted by the Recipient through one-on-one negotiation.

11. An enterprise wide task and commitment management system as recited in claim 4 wherein the Task Role is None—(Visibility rights only) and Task State is Accept, said accepted task being viewable by any one in the enterprise who has implicit visibility rights because they are in the upward, inline management of the Originator or the Recipient of the task.

12. An enterprise wide task and commitment management system as recited in claim 4 wherein the Task Role is Recipient and Task State is Submit, said task being submitted by the Recipient in the form of an RTF file or other file type based on filters loaded in the said system software.

13. An enterprise wide task and commitment management system as recited in claim 4 wherein the Task Role is None—(Visibility rights only) and said Task State is Submit, said submitted task being viewable by any one in the enterprise who has implicit visibility rights because they are in the upward, inline management of the Originator or the Recipient of the task.

14. An enterprise wide task and commitment management system as recited in claim 4 wherein the Task Role is Originator and said Task State is Submit, said submitted task being reviewed by the Originator to accept and close the task or reject and submit for rework by the Recipient.

15. An enterprise wide task and commitment management system as recited by claim 4, wherein inline managers using Task Role None—(Visibility Rights only) monitor the task generation, task execution and task submission and task commitment for:
a. generating employee performance appraisals and substantiating the appraisal with selective task content from the database;
b. mining the database for recurring tasks and multiple, linked recurring tasks to discover inefficiencies and consequently redesign a business process to gain efficiencies; and
c. providing first hand content of who did what and when to prove compliance of state or federal regulations.
